(19) United States
(12) Patent Application Publication
(10) Pub. No.: US 2020/0189478 A1
(43) Pub. Date: Jun. 18, 2020

(54) Headrest Hook Apparatus

(71) Applicants: Roy C. Sanchez, Las Vegas, NV (US); Marnel Estepa, Las Vegas, NV (US)

(72) Inventors: Roy C. Sanchez, Las Vegas, NV (US); Marnel Estepa, Las Vegas, NV (US)

(21) Appl. No.: 16/219,062

(22) Filed: Dec. 13, 2018

(51) Int. Cl. B60R 7/10; F16B 2/00; F16B 2/10; B60R 7/04

(52) U.S. Cl. CPC B60R 7/10; B60R 7/043; F16B 2/10; F16B 2/005

(57) ABSTRACT

A headrest hook with a rubber double hooks that mounts and clamps to the side of a headrest pole to hang a variety of hats and caps inside any vehicle car, truck, and SUV.

### BACKGROUND OF THE INVENTION

This invention is reference to patent number U.S. Ser. No. 14/980,378 a headrest hook apparatus that mounts to the side of a headrest invented by Roy Sanchez and Marnel Estepa. A new simple design of the headrest hook apparatus that has a rubber double hook for safety. The differences of the new design versus the previous design is the vertical stand base is a single piece part and the rubber double hook inserts on top of the vertical stand base. The simple version has a rubber double hook, a vertical stand base, and a elongated clamp.

### SUMMARY OF THE INVENTION

The headrest hook hanger apparatus can mount on any headrest pole to hang any hats and caps inside any vehicle.

### BRIEF DESCRIPTION OF THE DRAWINGS

FIG. 1 is a diagram of the headrest hook apparatus.

FIG. 2 is a diagram displays the swing clamp open and the latch open with the handle unlock.

FIG. 3 is a diagram of the headrest hook apparatus mounted to the side of a headrest pole on a car seat.

FIG. 4 is a exploded view of the headrest hook apparatus and all the parts.

### DETAILED DESCRIPTION OF THE PREFERRED EMBODIMENTS

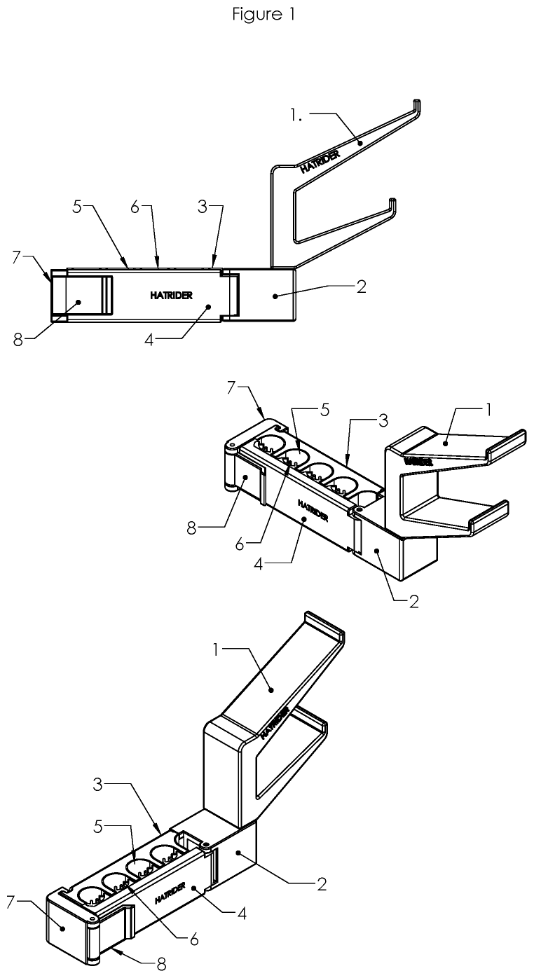

FIG. 1 is a diagram of the headrest hook apparatus; a rubber double hook 1 and the rubber double hook 1 with a slanted tip; a vertical stand base 2, which the rubber double hook inserts on top of the vertical stand base 2. An elongated clamp 3 with a series of rubber hole 5 is attach to the vertical stand base 2. A swing clamp 4 comprise of a series of a rubber teeth 6 attach to the swing clamp 4. The swing clamp 4 attach to a hinge to the vertical stand base 2. The two opposite side of the elongated clamp 3 and the swing clamp 4 are lock down together with a latch 7 and a handle 8 at the end of the elongated clamp 3. The elongated clamp has a series of rubber hole 5 insert into the elongated clamp that allows a headrest pole 11 to be position at different length of the elongated clamp 3.

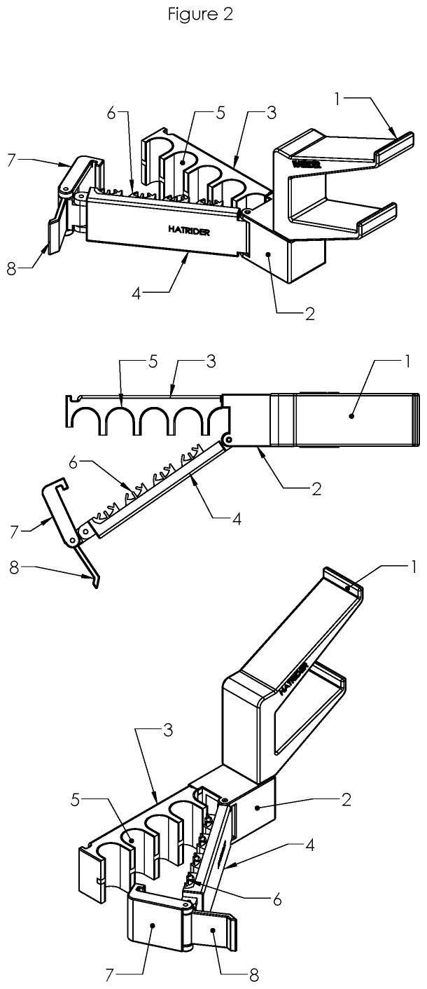

FIG. 2 is a diagram displays the swing clamp 4 opens and with the handle 8 unlock and latch open 7. When the swing clamp 4 is open it can slide a headrest pole 11 into any of the series of the rubber hole 5 long along the elongated clamp 3. The vertical stand base 2 and rubber double hook 1 are attach together.

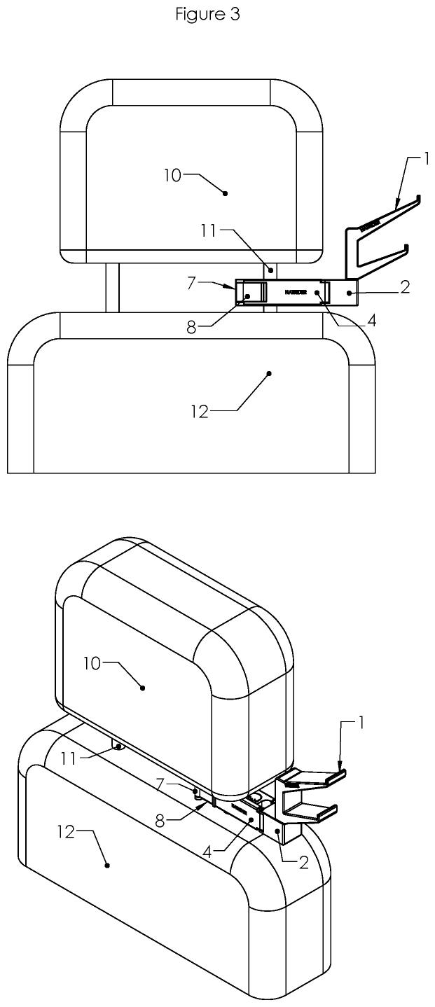

FIG. 3 is a diagram of the headrest hook apparatus mounted on a headrest pole 11 wherein the elongated clamp is clamp 3 is around the headrest pole 11. The headrest hook apparatus is mounted to the side of the headrest 10 and above the shoulder of a seat 12. The rubber double hook 1 slants and protrudes out from the side of the headrest 10. The vertical stand base 2 holds the rubber double hook 1 up and the elongated clamp 3 and swing clamp 4 are closed together around a headrest pole 11 with the latch 7 and handle 8 locks the opposite side together.

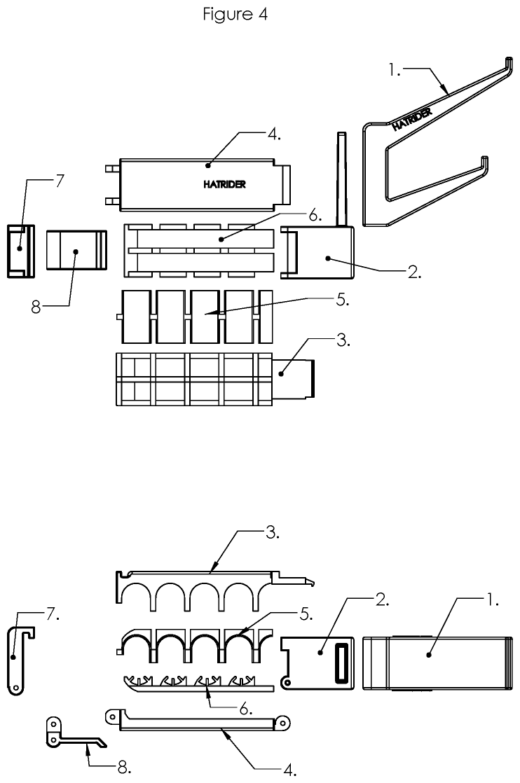

FIG. 4 is an exploded view of the headrest hook apparatus and the parts of which is assembled together. The rubber double hook 1 comprise a double slant hook made of a rubber material for safety. The vertical stand base 2 is a single part that allows the double rubber hook 1 to insert on the vertical stand base 2 and holds it up. The elongated clamp 3 and the swing clamp 4 are attach to the vertical stand base 2. Inside the elongated clamp is a series of rubber hole 5 and series rubber teeth 6 on the swing clamp 4. The end of the elongated clamp is comprise of the latch 7 and the handle 8 to close the two opposite side of the elongated clamp 3 and swing clamp 4 together.

The headrest hook apparatus can be adapted to use any universal clamp to mount to the headrest and use any different variations of hook design to hang hats and caps inside any vehicle along the side of the headrest.

1. A headrest hook apparatus comprising: a rubber double hook, an elongated clamp having first and second opposite sides; a vertical stand base; wherein the rubber double hook is attached to the vertical stand base; the vertical stand base is manufactured as one piece part and is attached to the elongated clamp;
wherein the elongated clamp comprises of two sides; a swing clamp on a hinge with a series or rubber teeth; a stationary clamp with a series or rubber holes.

2. The headrest hook apparatus of claim 1, wherein the latch attaches to a hinge and handle attaches a second hinge at the end of swing clamp to open and close the swing clamp, wherein the latch clips onto an outer side of elongated clamp and the handle is pulled back to lock down the latch to keep the elongated clamp together around the headrest pole.

3. The headrest hook apparatus of claim 1, wherein the rubber double hook is comprised of a slant on the rubber double hook; wherein the rubber double hook mounts on top of the vertical stand base,

4. The headrest hanger apparatus of claim 1, wherein the elongated clamp comprises: a hinge; and wherein the swing clamp of the elongated clamp is attach to the hinge of the vertical stand base and the hinge of the vertical stand base allows the swing clamp to open and close with respect to the vertical stand base.

5. The headrest hook apparatus of claim 1, wherein the vertical stand base is manufactured as one piece part.
